(19) United States
(12) Patent Application Publication
(10) Pub. No.: US 2010/0178141 A1
(43) Pub. Date: Jul. 15, 2010

(54) Auto Valet

(76) Inventor: Rich Wilson, Shady Cove, OR (US)

Correspondence Address: Rich Wilson, P.O. Box 592, Shady Cove, OR, 97539, US

(21) Appl. No.: 12/647,425

(22) Filed: Dec. 25, 2009

Related U.S. Application Data
(60) Provisional application No. 61/144,440, filed on Jan. 13, 2009.

(51) Int. Cl. B65G 67/20

(52) U.S. Cl. 414/373

(57) ABSTRACT

The Auto Valet trailer loading system is comprised of the following components which work together to move a vehicle into an enclosed trailer and secure it to the chassis of the trailer and return it to load position.

Chain track with locking mechanisms

Loading ramps

Dolly system powered by 12 Volt Battery driven winch

Wireless remote controller

### CROSS-REFERENCE TO RELATED APPLICATIONS

This application is to transfer the existing provisional patent (EFS ID 4607620/Application No. 61/144,440—filed Jan. 13, 2009) for the Auto Valet into a Provisional Utility Patent.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Auto Valet vehicle loading system was design for loading and unloading of vehicles in enclosed trailers. A provisional patent for this system was filed on Jan. 13, 2009 under Application No. 61/144,440. The Auto Valet addresses the following issues:
1. Vehicle does not have to be driven into the trailer which eliminates issues with sight visibility (potential damage to vehicles by scraping wheel wells),
2. Difficulty for driver to exit the vehicle once loaded within the trailer as vehicle doors do not have room to open so driver has to crawl out window,
3. Having to crawl around the front end of the trailer to secure the vehicle for transportation, and
4. Ease of unloading the vehicle as the dolly system will release the locking mechanism and back the vehicle out of the trailer.

This system was designed by a custom car builder who has spent 30 years dealing with the difficulties of loading high cost, specialty vehicles into enclosed trailers.

### BRIEF SUMMARY OF THE INVENTION

The Auto Valet system provides an easy method for loading and unloading vehicles in enclosed car trailers. The system has a remote controlled (battery powered) dolly system that rides on a track system (similar to a conveyor). A vehicle is driven onto the dolly at the end of the trailer and secured to the dolly. The remote controlled dolly is then activated and will pull the vehicle into the trailer. Once the dolly reaches the end of the track, the dolly is automatically secured to the frame of the trailer. The advantages of utilizing this system include:
1. Vehicle does not have to be driven by a person into the trailer
2. Driver therefore does not have to exit the vehicle once it is loaded into the trailer
3. Front of vehicle does not have to be manually tied down or secured.

### BRIEF DESCRIPTION OF THE SEVERAL VIEWS OF THE DRAWING

### Page 1

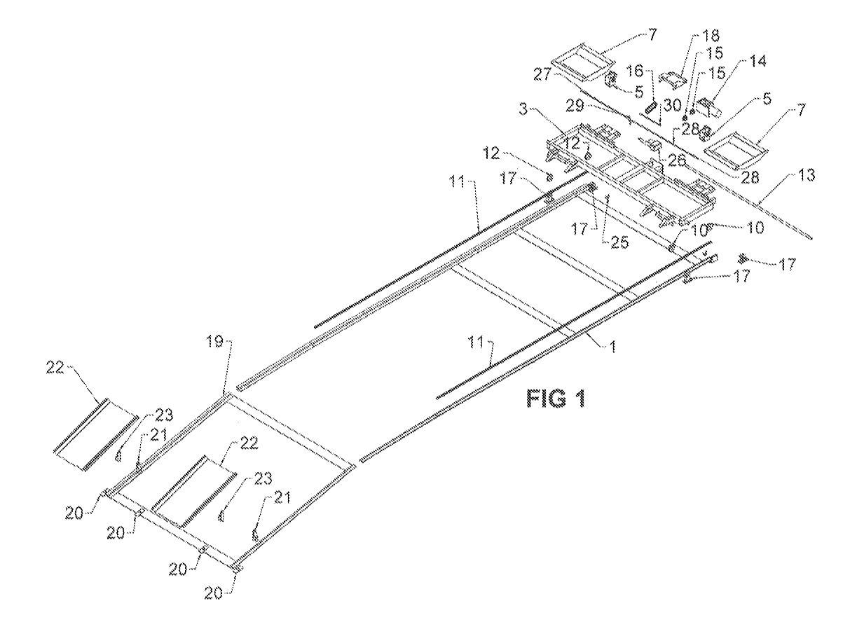

FIG. 1—Complete rail, ramp and dolly assembly

### Page 2

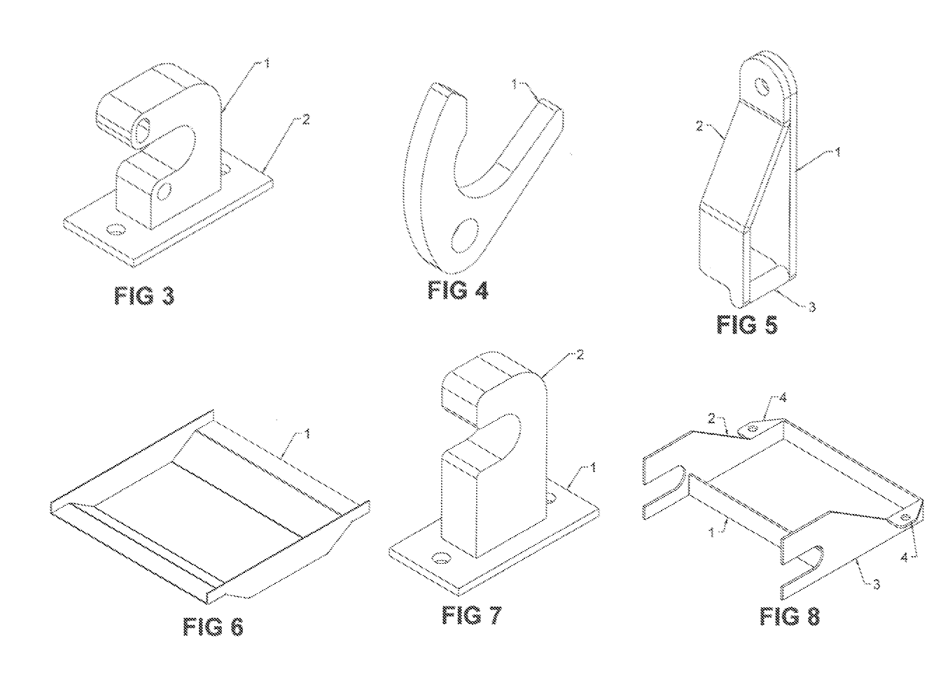

FIG. 3—Front cam over latch base

FIG. 4—Front cam over latch

FIG. 5—Ramp hinge

FIG. 6—Wheel Tray

FIG. 7—Rear anchor

FIG. 8—Battery Tray

### Page 3

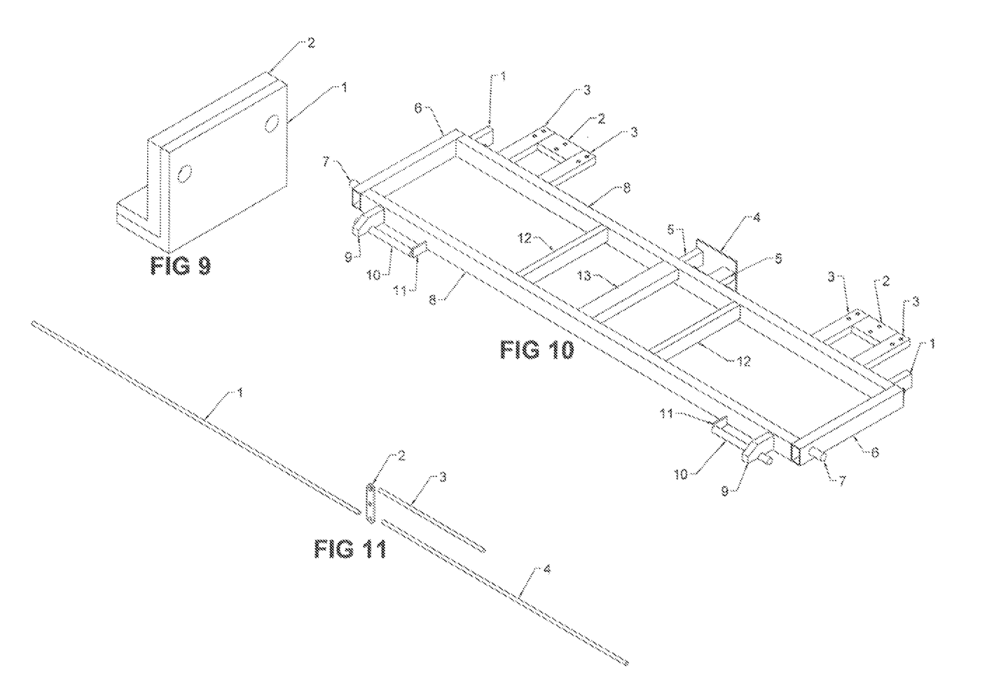

FIG. 9—Guide plate with bushing

FIG. 10—Dolly assembly

FIG. 11—Lock mechanisms/Linkage

### DETAILED DESCRIPTION OF THE INVENTION

Two parallel base rails that support chain track assemblies (FIG. 1—Items 1 & 11) are installed with screws on the floor of the trailer, as well as the trailer door/ramp, and anchored to the chassis at the front of the trailer (this is where the locking mechanisms (FIGS. 3, 4 & 7) will be secured to the chassis as well). Number 40 chain (FIG. 1 Item 11), which serves as a track for the dolly (FIG. 10), is then anchored via chain attachment links to the base rails on the floor area of the trailer. The chain is secured to the trailer door/ramp area (inside the door/ramp) to ensure adequate tension of the chain is maintained at different tailgate opening angles.

On the trailer door the loading ramps (FIG. 1 Item 22) and hinges (FIG. 5) are installed utilizing bolts and screws. The ramps are hinged to facilitate the dolly, which is approximately 2-3 inches from the trailer floor, traveling down the track and raising the ramps to allow for level access to the wheel trays (FIG. 6). There are two safety switches located near the ramps that will automatically shut off the power to the dolly to avoid the dolly from running off of the track. Once the vehicle is attached to the dolly via tire straps, the dolly will power the vehicle forward into the trailer. As the dolly moves away from the ramps, the hinges will return back to a lower setting so that the rear wheels of the vehicle travel on a level surface.

At the front of the trailer, there are two cam over anchor locks (FIG. 3 & 4) and two rear anchors (FIG. 7) which are installed with bolts to the chassis of the trailer. As the dolly travels forward into the rear anchor and cam over latch mechanism, there are two safety switches that stop the dolly and trip lock actuator (FIG. 1 Item 26). The lock actuator works the lock mechanisms/linkage (FIG. 11) which works in conjunction with the cam over latch mechanism to anchor the dolly securely to the chassis of the trailer.

To ensure that the dolly, which utilizes sprockets for wheels, remains in contact and alignment on the chain track, there are four guide plates with bushings (FIG. 9) at each corner of the dolly. The winch motor that runs the dolly is powered from a 12 volt battery mounted on the dolly (FIG. 8/FIG. 11 Item 18). The winch motor is activate by a wireless remote control device. The winch transfers it's drive power to the axel via chain and sprockets.

1. I claim the auto valet vehicle loading system as my invention. There is no other similar product or system invented to date designed for the sole purpose of loading, securing and unloading vehicles in enclosed trailers.
